(19) United States
(12) Patent Application Publication
(10) Pub. No.: US 2010/0099373 A1
(43) Pub. Date: Apr. 22, 2010

(54) PERSONALIZED ANSWERING MACHINE

(75) Inventor: Claudia V. Goldman-Shenhar, Mevasseret Zion (IL)

Correspondence Address: KEVIN D. MCCARTHY;ROACH BROWN MCCARTHY & GRUBER, P.C., 424 MAIN STREET, 1920 LIBERTY BUILDING, BUFFALO, NY, 14202, US

(73) Assignee: SAMSUNG ELECTRONICS CO., LTD., Gyeonggi-do (KR)

(21) Appl. No.: 12/252,555

(22) Filed: Oct. 16, 2008

(51) Int. Cl. H04M 11/04; H04M 3/42

(52) U.S. Cl. 455/404.1; 455/414.1

(57) ABSTRACT

A system for handling incoming calls in a communication device comprises logic processing elements suitable to relate between parameters of the incoming call and the context of the user of said communication device and to react to each incoming call based on the relationship so determined.

### FIELD OF THE INVENTION

The present invention relates to the field of answering machines. More particularly the invention relates to personalized answering machines that generate responses as a function of specific inputs. Thus the invention addresses problems related to human-computer interaction, particularly with reference to mobile devices

### BACKGROUND OF THE INVENTION

It is well known in the art to provide answering machines which, when the user is unavailable for answering an incoming call or message, will play a pre recorded message to the callers. In the context of the present invention the term “answering machine” is used in its broadest sense, to include voicemail systems, whether part of a WAN or not, land line answering machines and mobile devices/cellular phone answering machines/voicemail systems. Such systems include voice mail systems that can also send an SMS to callers when the user is not available. Other solutions include personalized greetings based on the caller and possible activity of the user (pre-set by him), such as “in conference” or the like messages.

Prior art systems suffer from different drawbacks, such as:
they do not follow up on the messages sent to the callers and on the actions to which the user has committed himself;
they do not adapt the messages to the callers based on the context of the user; and
they do not recognize exceptions to the callers or events, and are unable to change their behavior in a manner adaptive to the user.

Throughout this description the term “context”, when used in relation to a user, is meant to indicate the status of the user, both physically (as determined by GPS or other sensors) and a logically, as determined by information available to the mobile device, such as schedules, incoming and outgoing messages, habits and preset preferences.

### SUMMARY OF THE INVENTION

In one aspect the invention relates to a system for handling incoming calls in a communication device, comprising logic processing elements suitable to relate between parameters of the incoming call and the context of the user of said communication device and to react to each incoming call based on the relationship so determined. Preferably the communication device is a mobile device.

According to an embodiment of the invention the relationship between call parameters and user context are used to identify an irregular call, such as an emergency call.

The call parameters used by the invention can be of any suitable type and include, for instance, the communication patterns of the user. According to an embodiment of the invention the relationship between call parameters and user context are used to generate follow-up actions required to further handle the incoming message.

The follow-up actions taken as a result of a call can be of any kind and include, for example, reading a message, listening to voice mail, placing a call or performing a physical action, such as any action that can be taken with the mobile device, including recording, taking a picture, writing text, sending a message such as by chat, sms or mail, and performing a call.

In one embodiment of the invention the context of the user is determined by analyzing data available from the communication device, which include, but are not limited to, one or more of time schedule information, recorded habits of the user, and textual messages.

The data available from the communication device my also come from physical source, such as data obtained from sensors of physical data, such as that obtainable from one or more of GPS, light sensors and temperature sensors.

In another aspect the invention is related to a method for handling incoming calls in a communication device, comprising providing an agent in the communication device, suitable to relate between parameters of the incoming call and the context of the user of said communication device, and reacting to each incoming call based on the relationship so determined. The means and parameters used to carry out the method have been described in detail above, with reference to the system of the invention, and are therefore not repeated here, for the sake of brevity.

### BRIEF DESCRIPTION OF THE DRAWINGS

In the drawings:

FIG. 1 is a flowchart illustrating the operation of an example of a personalized answering machine, according to an embodiment of the present invention.

### DETAILED DESCRIPTION OF THE INVENTION

The system according to the invention handles the entering calls of a user that is unavailable to answer them by himself. The system is controlled by a personal software agent that has access to the user's status, context and data on the mobile phone. The system of the invention operates differently than prior art systems, some of which are listed below:

1. SilentCommunication.com, that allows the user to maintain conversations silently by sending preset messages or text messages to the caller and receiving the responses in text form;

2. SMS Answering machine by Boo! Interactive (http://classic.pocketgear.com/software_detail.asp?id=18382&associateid=9)—in which the user can pre-set different reply messages to each contact person.

3. Patent EP 1 072 159 B1—“System and Procedure For Implementing An Answering Machine”—according to which an SMS is sent to a caller based on the user's calendar when he cannot be reached.

4. Patent US 2007/0238474 A1—“Instant Text Reply For Mobile Telephony Devices”—which is a system that allows a user to set one SMS with predefined text that will be sent to all callers for a period of time determined by the user.

5. PowerGramoSkype Recorder (http://www.sharewareconnection.com/powergramo-skype-recorder.htm)—allows the user to record personalized greetings based on the calling contact when unavailable in Skype.

The invention will be explained in the description to follow using a mobile device, such as may be a cellular phone, as the illustrative system. The system is operated using an agent, located in the mobile device, which can typically be a software program or a logic circuit. The main stages of the agent's behavior are detailed below.

The Personalized Answering Agent Behavior

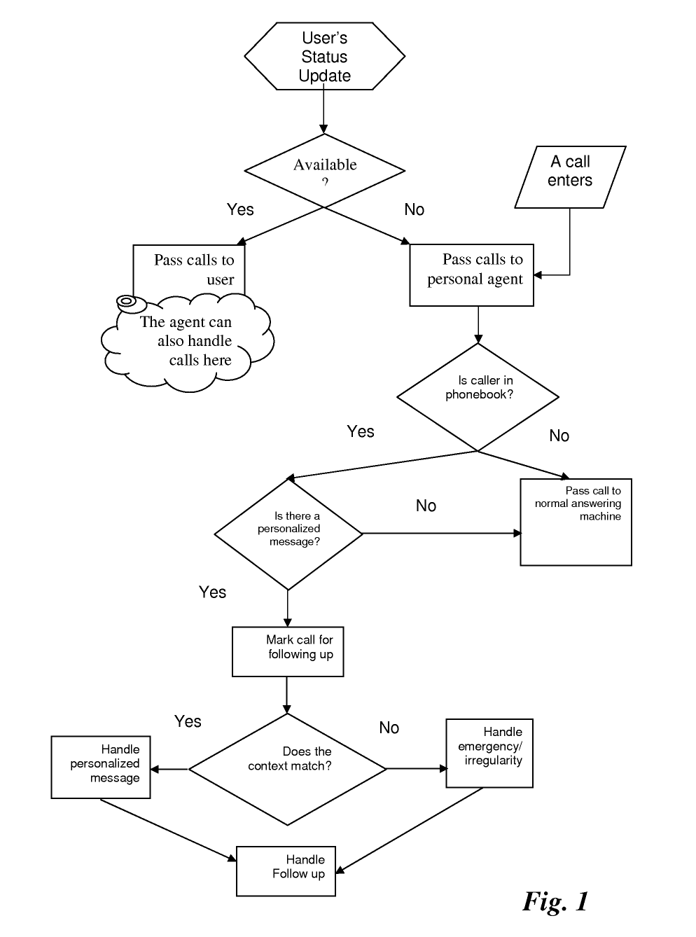

The personal agent is an active process on the mobile phone that receives entering calls and handles them based on the user's status, context and data. This process, the operation which is illustrated In FIG. 1, covers four separate stages as follows. Note that the “preparing personalized messages”, “status update” and the “entering calls” processes can occur asynchronously to the agent's process. The first two of these processes are locked while the user performs the relevant action and the agent runs with the information available to it. The agent has at least some notion about the user's context (for example, based on information taken from the user's calendar: working, driving to work, sleeping, at home. Other information, pertinent to the location of the user, can be deduced from the GPS of the mobile device.)
1. Preparing personalized messages—The user can record messages that will be played by his personal agent when he is unavailable to answer the call and he prefers his messages over the regular answering machine. Each message, in this specific example, will have four fields:
   a. the contact/category of contacts (to whom),
   b. the context of the user (when),
   c. the content of the message (what)
   d. the follow-up action (what to do next)
2. User's status—In this stage, the status of the user is set/updated
   a. Manually by the user
   b. Automatically by the personal agent with the user's confirmation (for example, a user leaves a meeting and the agent asks whether he can change the user's status to “available”).
   c. Automatically by the personal agent based on information from the user's calendar, GPS, or other sensors.
3. Incoming call handling—when the user's status is set to “unavailable” (the user cannot answer the call by himself), the personal agent needs to recognize who the caller is and react according to his behavioral rules. In the following cases, the user may configure the agent to handle the calls without showing the user that that particular call entered, or having the agent handling the call also showing this to the user, or having the agent show the call to the user and wait for the user's confirmation. According to the particular example referred to above:
   a. If the caller's number is not identifiable, the caller will be routed to the regular answering machine.
   b. If the caller's number is identifiable but the contact details do not appear in the user's phone book, then the caller will be routed to the regular answering machine.
   c. If the caller's number is identifiable as a contact in the user's phone book then
      i. If there is a personalized prerecorded message for this contact and the message corresponds to the user's current context then the particular message is played to the caller. The agent also marks this call to be tracked.
      The user may have recorded several messages for the same contact for different contexts, so the right one needs to be chosen by the agent.
      ii. If there is a personalized prerecorded message for this contact but there is a mismatch in the context of the user, then it means that an irregularity in the caller pattern is recognized.
         1. If that irregularity can be identified as an emergency, the personal agent will:
            a. Pass the call through if possible
            b. If the call cannot be passed through, then the personal agent will forward the call to a predetermined number for this type of emergencies.
         2. If that irregularity can be identified as a call with high priority the personal agent will
            a. Pass the call through
            b. React in some predetermined manner set by the user (for example when his boss calls at an unusual time of the day.)
4. Following up: Each prerecorded message that was marked for follow up is analyzed based on its text and the follow-up field.
   a. If the user committed himself to calling back, then a reminder is set in the user's calendar and the personal agent will remind the user based on the adjustable autonomy features of this user.
   b. The agent may use information from the user's calendar to remind the user when he is out of a meeting about the calls he got and ask for guidance as to how to continue.
   c. If an important/emergency call was received and forwarded a reminder to the user will be presented to check on the situation.
   d. Additional follow-ups can be considered based on the types of messages that the user may leave as prerecorded. Some illustrative examples of prerecorded messages include:
      i. “I will call back after the meeting”
      ii. “I will buy the flowers on my way home”
      iii. “I will pick up Jimmy at 4 pm”

Agent-User Relationship

Preferences must be set by the user in order to initiate the learning process of the agent. In the particular example of the preferences settings given herein the user configures his personal agent as follows:
1. What calls will be shown as entering when the user is unavailable?
2. What calls are shown but handled automatically by the agent?
3. What calls are shown and will wait for the user decision as to how to handle them?
4. What calls will not be shown and will be handled by the agent?
5. The agent needs to present summaries of calls entered and handled and which follow up actions were taken to the user. A decision here is needed as when to do this, how to do this and with what frequency.

Associating Messages and Contacts

In the illustrative and non-limitative example used herein the user fills in the four fields of each message (to whom, content, the context, and the follow up action). The agent needs to choose the right message and take control of the follow-up action. Templates and menus can be used for the user to choose options easily and avoid the need to enter information explicitly by himself.

One of the important advantages of the invention is that emergencies are determined based on irregularities in pattern and not merely by a mismatch of contexts.

### Use Case Example

Each item below represents a change in the user's context. The status of the user as to whether he can or cannot receive calls will be set explicitly by the user or will be deduced by the agent with a possible confirmation of the user.

Whenever a call enters, based on the user's status the personal agent will send back a prerecorded message based on the user's context and caller's contact information. Then, based on the configuration of the autonomy of the agent, the agent will inform the user as to the entered calls and the actions taken.

Typical Thursday
1. A user turns on his phone; his status is available by default.
2. The user gets into his car
3. The user reaches the parking lot
4. The user enters his office
5. The user enters a meeting for the next 2 hours
6. The user goes out of the meeting
7. The user is at lunch break
8. The user has a management meeting that starts on time but finishes after 3 hours (instead of the planned 2).
9. The user is in his car
10. The user is on his way home
11. The user is at home
12. The user is sleeping

Typical Weekend
1. The user turns on his phone; his status is available by default
2. Family time
3. Friends
4. Party/noise

As a simplified example, a call by the user's boss during family time on the weekend would be identified as an emergency that must be brought to the user's immediate attention. Likewise, a call placed on Thursday by a family member during office hours would be considered an emergency, because said family member knows better than disturbing the user during work. On the other hand, a call by the same family member while the user is in his car on his way home will not be considered an emergency and, depending on the settings will be answered automatically, or by the user. The agent will know that the user is driving based on input from both the GPS and the Outlook schedule according to which the working day is over by a length of time such that the user must still be on his way home.

As will be apparent to the skilled person the invention affords several important advantages, among which are the following:
Emergencies and irregular calls are handled separately from normal calls and a separate behavior is given to the agent.
Follow-ups on the messages sent to callers are tracked and handled by the personal agent.
If more than one message exists for a certain contact or category, the personal agent will be able to choose the fittest one based on the user's context.

All the above explanations and description have been provided for the purpose of illustration and are not meant to limit the invention in any way. Many variations and alternative setups and corporations can be provided in the invention, without exceeding its scope.

1. A system for handling incoming calls in a communication device, comprising logic processing elements suitable to relate between parameters of the incoming call and the context of the user of said communication device and to react to each incoming call based on the relationship so determined.

2. A system according to claim 1, wherein the communication device is a mobile device.

3. A system according to claim 1, wherein the relationship between call parameters and user context are used to identify an irregular call.

4. A system according to claim 3, wherein the irregular call is an emergency call.

5. A system according to claim 3, wherein the call parameters include the communication patterns of the user.

6. A system according to claim 1, wherein the relationship between call parameters and user context are used to generate follow-up actions required to further handle the incoming message.

7. A system according to claim 6, wherein the follow-up actions include reading a message, listening to voice mail, placing a call or performing a physical action.

8. A system according to claim 7, wherein the physical action is any action that can be taken with the mobile device, including recording, taking a picture, writing text, sending a message such as by chat, sms or mail, and performing a call.

9. A system according to claim 1, wherein the context of the user is determined by analyzing data available from the communication device.

10. A system according to claim 9, wherein the data available from the communication device includes one or more of time schedule information, recorded habits of the user, and textual messages.

11. A system according to claim 1, wherein the data available from the communication device include sensors of physical data.

12. A system according to claim 11, wherein the sensors of physical data are selected from one or more of GPS, light sensors and temperature sensors.

13. A method for handling incoming calls in a communication device, comprising providing an agent in the communication device, suitable to relate between parameters of the incoming call and the context of the user of said communication device, and reacting to each incoming call based on the relationship so determined.

14. A method according to claim 13, wherein the communication device is a mobile device.

15. A method according to claim 13, wherein the relationship between call parameters and user context are used to identify an irregular call.

16. A method according to claim 15, wherein the irregular call is an emergency call.

17. A method according to claim 15, wherein the call parameters include the communication patterns of the user.

18. A method according to claim 13, wherein the relationship between call parameters and user context are used to generate follow-up actions required to further handle the incoming message.

19. A method according to claim 18, wherein the follow-up actions include reading a message, listening to voice mail, placing a call or performing a physical action.

20. A method according to claim 19, wherein the physical action is any action that can be taken with the mobile device, including recording, taking a picture, writing text, sending a message such as by chat, sms or mail, and performing a call.

21. A method according to claim 13, wherein the context of the user is determined by analyzing data available from the communication device.

22. A method according to claim 21, wherein the data available from the communication device includes one or more of time schedule information, recorded habits of the user, and textual messages.

23. A method according to claim 21, wherein the data available from the communication device include sensors of physical data.

24. A method according to claim 23, wherein the sensors of physical data are selected from one or more of GPS, light sensors and temperature sensors.
